(19) United States
(12) Patent Application Publication
(10) Pub. No.: US 2016/0228855 A1
(43) Pub. Date: Aug. 11, 2016

(54) CATALYST FOR PREFERENTIAL OXIDATION AND MANUFACTURING METHOD FOR THE SAME

(71) Applicant: KOREA ADVANCED INSTITUTE OF SCIENCE AND TECHNOLOGY, Daejeon (KR)

(72) Inventors: Joong Myeon Bae, Daejeon (KR); Ji Woo Oh, Daejeon (KR)

(21) Appl. No.: 15/018,455

(22) Filed: Feb. 8, 2016

(30) Foreign Application Priority Data
Feb. 9, 2015 (KR) 10-2015-0019670

(51) Int. Cl. B01J 23/83

(52) U.S. Cl. CPC B01J 23/83

(57) ABSTRACT

Provided is a catalyst for preferential oxidation for fuel reforming which includes a ceria support containing gadolinium, and a metal catalyst supported on the ceria support.

### CROSS-REFERENCE TO RELATED APPLICATION

This application claims priority of Korean Patent Application No. 10-2015-0019670, filed on Feb. 9, 2015, in the KIPO (Korean Intellectual Property Office), the disclosure of which is incorporated herein entirely by reference.

### BACKGROUND OF THE INVENTION

1. Field of the Invention

The following disclosure relates to a catalyst for preferential oxidation for fuel reforming and a method for preparing the same. More particularly, the following disclosure relates to a catalyst for preferential oxidation for fuel reforming that uses a support containing gadolinium to allow high-quality preferential oxidation even at high temperature, and a method for preparing the same.

2. Description of the Related Art

A fuel cell is an energy conversion system by which the intramolecular chemical energy of an oxidant and fuel is converted into electric energy. Since such a fuel cell uses an electrochemical mechanism, it has an advantage of higher energy conversion efficiency as compared to the conventional heat engines based on a thermodynamic mechanism. The term ‘fuel cell’ refers to any systems for converting chemical energy of fuel directly into electric energy, including a fuel cell stack, power generation system, balance of plant (BOP) and a related control system. Particularly, fuel cell technology using hydrogen as fuel has been spotlighted as a method for pollution-free clean alternative energy conversion that prepares for environmental pollution problems caused by power generation and conversion, such as global warming or Fukushima nuclear disaster.

Such a fuel cell requires hydrogen as feed gas and a process for producing hydrogen from fossil fuel, such as diesel, is referred to as a fuel reforming process. One of such fuel reforming processes is preferential oxidation (Prox) using the reaction scheme described hereinafter.

A catalyst plays a critical function in preferential oxidation. This is because there is activation energy for oxidation of carbon monoxide, and thus it is required to reduce such activation energy to obtain a desired low concentration of carbon monoxide.

However, although active studies have been conducted about catalytic metals, studies about interaction between a metal catalyst and a support are not sufficient yet.

### SUMMARY OF THE INVENTION

An embodiment of the present disclosure is directed to providing a novel catalyst for preferential oxidation for fuel reforming which has high catalytic activity while using a cheap metal catalyst not a noble metal, and a method for preparing the same.

In one aspect, there is provided a catalyst for preferential oxidation for fuel reforming, the catalyst comprising a ceria support containing gadolinium, and a metal catalyst supported on the ceria support.

In one aspect, there is provided a catalyst for preferential oxidation for fuel reforming, wherein the ceria support contains gadolinium in an amount of 0.05-0.1 mol %.

In one aspect, there is provided a catalyst for preferential oxidation for fuel reforming, wherein the metal catalyst is copper.

In one aspect, there is provided a catalyst for preferential oxidation for fuel reforming, wherein the copper is contained in amount of more 0.5 weight % less than 10 weight % to the catalyst.

In one aspect, there is provided a catalyst for preferential oxidation for fuel reforming, wherein the range of operation temperature of the catalyst is equal to or more than 20° C.

In one aspect, there is provided a fuel reformer containing a catalyst as mentioned above.

According to the present disclosure, a ceria support containing gadolinium is used as a support for cupric oxide catalyst, and thus oxygen is supplied continuously to cupric oxide, thereby improving the catalytic activity and reducing the cost required for operating preferential oxidation.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a schematic view illustrating the reaction of the gadolinium-doped ceria support/cupric oxide catalyst according to an embodiment.

FIG. 2 shows XRD result for the catalysts with various content of gadolinium,

FIG. 3 shows the schematic diagram for the experimental devices used in the experiment below.

FIG. 4 shows the test results for the quality of CuO/CGO as compared to that of CuO/CeO₂.

FIG. 5 and FIG. 6 show a graph illustrating the concentration of carbon monoxide emission and a graph illustrating CO conversion rates, respectively, in the CuO/CGO catalysts using supports having different gadolinium contents.

FIG. 7 shows the results of carbon monoxide conversion rates in the supports using different doping elements.

FIG. 8 shows CO version rate of CuO/CGO catalyst without gadolinium and CuO/CGO catalysts using supports having different gadolinium contents.

FIG. 9 shows test result regarding Cu contents.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

To solve the above mentioned problem, according to an embodiment, gadolinium (Gd) having a charge of +3 is incorporated to a ceria support having a charge of +4. In this case, a cerium atom is substituted with a gadolinium atom, resulting in an electron unbalance of +1. Such an electron unbalance causes degradation of mechanical strength of non-conductive ceramic and also functions as a crystal defect that may lead to destruction of crystal. However, according to an embodiment, the support has a quality of retaining or releasing external oxygen in order to solve the electron unbalance caused by the incorporation of such an element having a charge of +3. Finally, this functions to supplement oxygen that may be depleted subsequently according to the catalytic reaction of cupric oxide.

Particularly, according to an embodiment, gadolinium having an atomic size similar to the atomic size of cerium is supported on a support as an element of lanthanides like cerium so that the effect of supporting and supplying oxygen from the support may be maximized.

According to an embodiment, cupric oxide is used as a catalytic metal on the catalyst support.

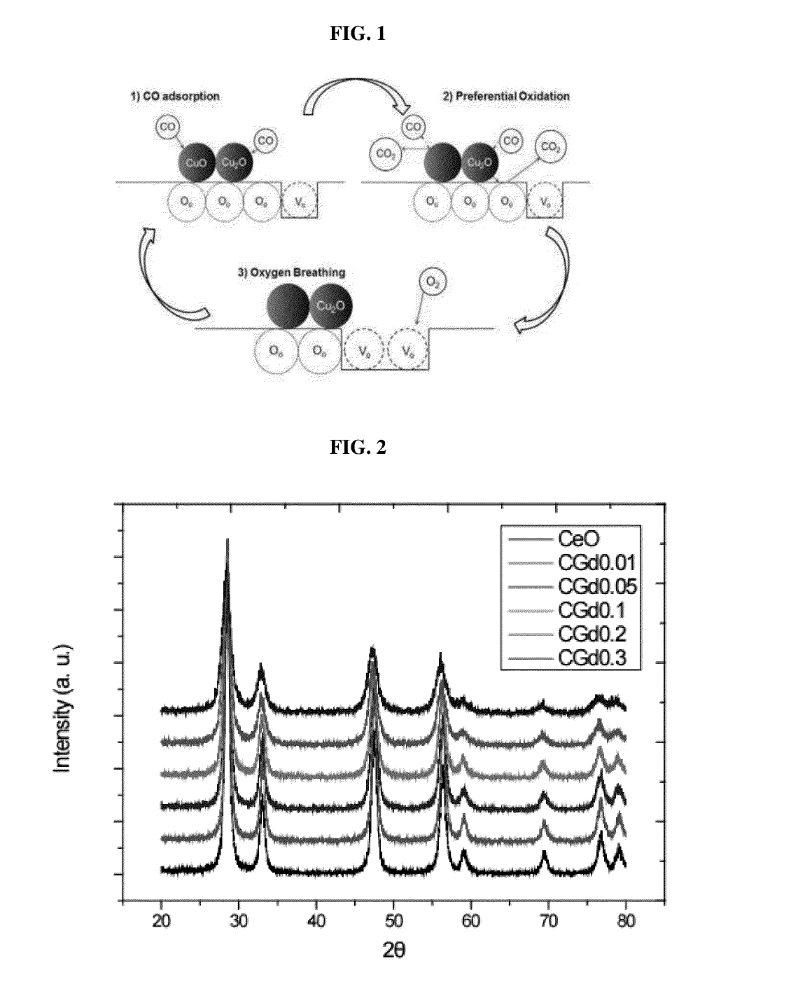

FIG. 1 is a schematic view illustrating the reaction of the gadolinium-doped ceria support/cupric oxide catalyst according to an embodiment.

Referring to FIG. 1, oxygen floating in the air joins two free electrons on the surface of ceria on which a transition metal is supported, and then is converted into two active oxygen species. Such active oxygen species infiltrate into the gap of ceria formed as electrical vacancy caused by the incorporation of a transition metal. Herein, the gap of ceria is oxygen vacancy. According to an embodiment, gadolinium that has a size similar to the size of cerium and belongs to the same group as cerium is used to maximize the effect of supporting and supplying oxygen caused by the oxygen vacancy.

Then, the active oxygen species inserted into the support respond to the surrounding electromagnetic condition and are stabilized, while the free electrons float again in the ceramic. FIG. 1 shows the actual situation of the generated preferential oxidation.

### EXAMPLE

Preparation of Catalyst

As a catalyst support, a ceria support containing gadolinium (CGO, ANAN KASEI Co., Ltd.), used is CGO containing cerium and gadolinium at an atomic ratio of 0.9:0.1 per molecule. Then, copper (Cu, 10 wt %) is supported on CGO. Herein, an incipient wetness impregnation (IWI) method that includes applying metal nitrate onto a dry support is used to support copper. Then, the wet support on which nitrate is supported is dried for 24 hours overnight, and then subjected to calcination at 500° C. under air for 4 hours. After the calcination, the catalyst is formed into granules to carry out a preferential oxidation test in a microchannel.

For the experiments below, catalysts were prepared in the same method as mentioned above with content of gadolinium, 0, 0.01, 0.05, 0.1, 0.2, 0.3 mol %. Each of which is referred to as CuO/CGO, CuO/Ce_{0.99}Gd_{0.01}O₂, CuO/Ce_{0.95}Gd_{0.05}O₂, CuO/Ce_{0.9}Gd_{0.1}O₂, CuO/Ce_{0.8}Gd_{0.2}O₂, CuO/Ce_{0.7}Gd_{0.3}O₂.

FIG. 2 shows XRD result for the catalysts with various content of gadolinium,

Referring to FIG. 2, peaks of graph show shift according to the content of gadolinium. It evidences that gadoliniums with different content are contained in the catalyst.

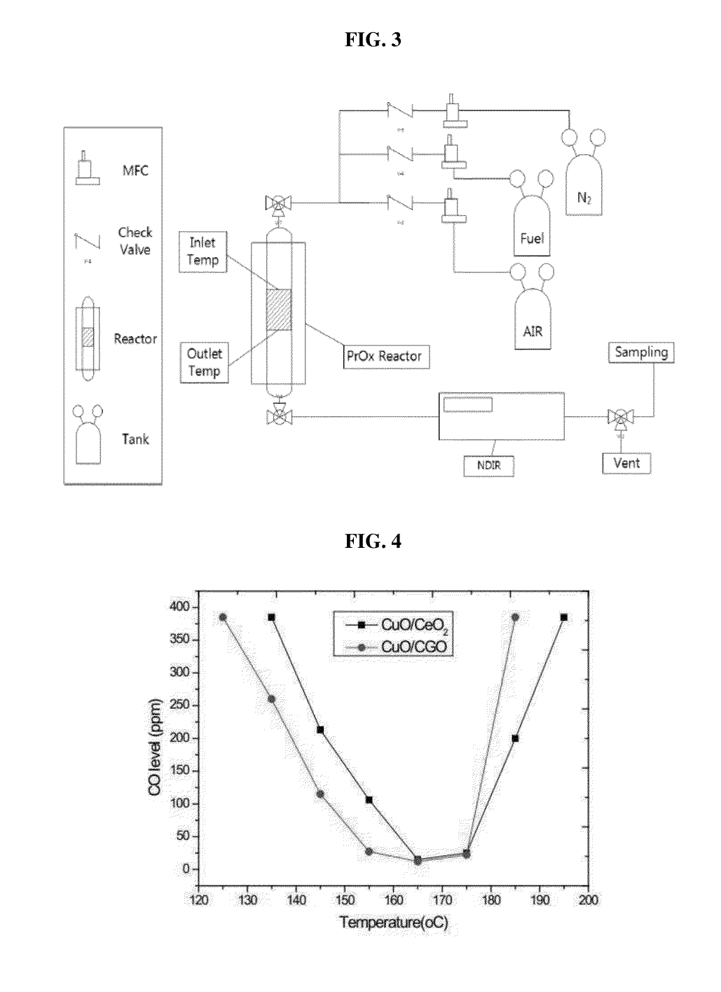

FIG. 3 shows the schematic diagram for the experimental devices used in the experiment below.

The fuel gas used in the below example contains hydrogen 37.84 vol %, CO₂ 17.6 vol %, CO 0.88 vol %, nitrogen 31.68 vol %, H₂O 12.0 vol %

### Test Example 1

Quality Test for Ceria Support and Gadolinium-Containing Ceria Support

FIG. 4 shows the test results for the quality of CuO/CGO as compared to that of CuO/CeO₂.

Referring to FIG. 4, CuO/CGO according to an embodiment shows effective quality over a broader operation temperature range (≧20° C.) as compared to CuO/CeO₂. In other words, it can be seen that when compared to a ceria support, the gadolinium-containing support according to an embodiment shows an operation temperature range nearly about two times of the operation temperature range of the ceria support, 10° C.

Test Example 2

Effect of Gadolinium Content

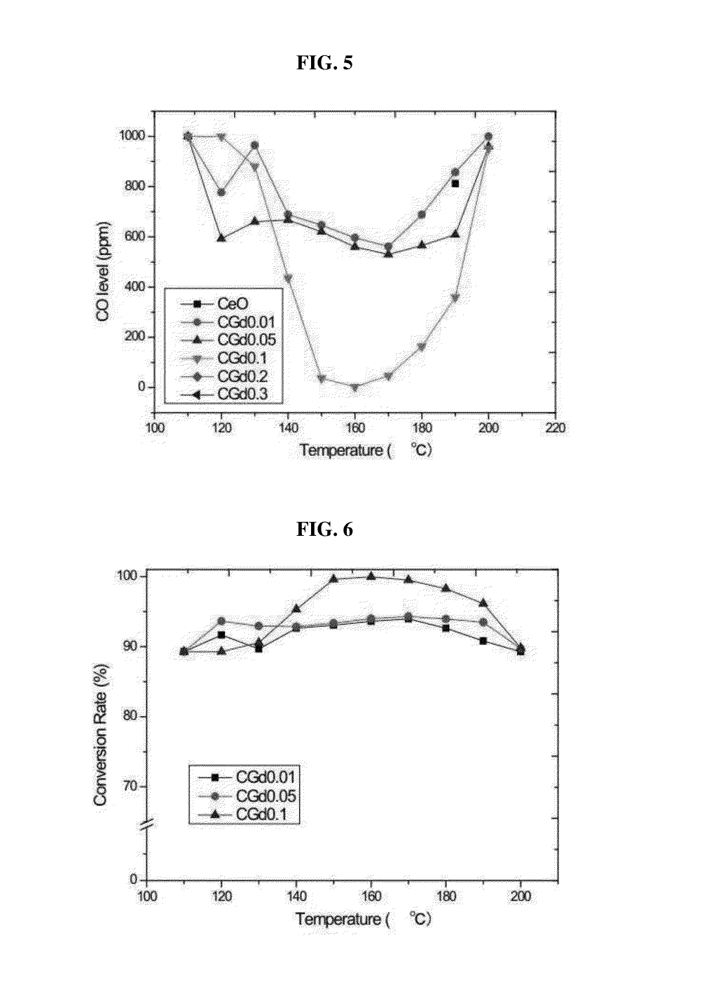

FIG. 5 and FIG. 6 show a graph illustrating the concentration of carbon monoxide emission and a graph illustrating CO conversion rates, respectively, in the CuO/CGO catalysts using supports having different gadolinium contents.

Referring to FIG. 6 and FIG. 4, CuO/Ce_{0.9}Gd_{0.1}O₂ on which 0.1 mol % of gadolinium is supported shows the highest quality. This is followed by CuO/Ce_{0.95}Gd_{0.05}O₂ on which 0.05 mol % of gadolinium is supported and CuO/Ce_{0.99}Gd_{0.01}O₂ on which 0.01 mol % of gadolinium is supported. When using a support on which no gadolinium is supported, carbon monoxide is emitted in an amount larger than 1000 ppm, which is within a detectable range in the case of CuO/CeO₂ or in the case of CuO/Ce_{0.8}Gd_{0.2}O₂ or CuO/Ce_{0.7}Gd_{0.3}O₂ on which gadolinium is supported in an amount larger than 0.1 mol %. Therefore, the ceria support according to an embodiment preferably contains gadolinium in an amount of 0.05-0.1 mol %.

### Test Example 3

Comparison Test Using Different Doping Elements

The supports (CSO, CZO) containing samarium (Sm) and zirconium (Zr) instead of gadolinium are prepared. The supports provided in this example have the formulae of Ce_{0.9}Sm_{0.1}O₂ and Ce_{0.9}Zr_{0.1}O₂.

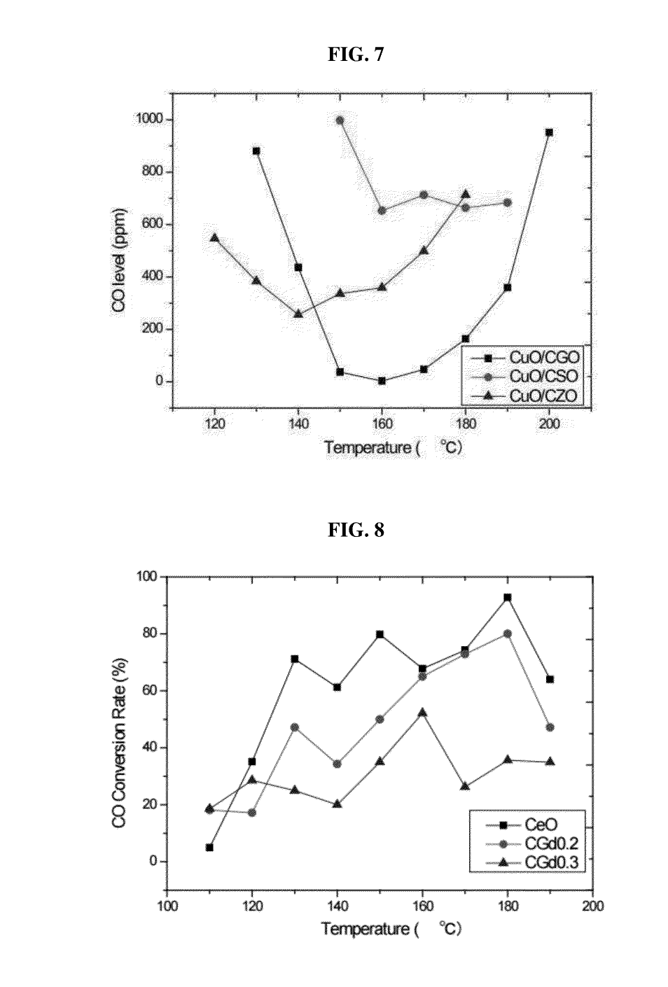

FIG. 7 shows the results of carbon monoxide conversion rates in the supports using different doping elements.

Referring to FIG. 7, when determining the CO emission of the support (CuO/CGO) according to an embodiment over a temperature range of 140-190° C., the CO emission is significantly lower in a temperature range of 140-180° C.

FIG. 8 shows CO version rate of CuO/CGO catalyst without gadolinium and CuO/CGO catalysts using supports having different gadolinium contents.

Referring to FIG. 8, the catalyst with more than 2% of gadolinium shows less than 90% of CO version rate. Accordingly, contents of gadolinium is between 0.05-0.1 mol % preferably.

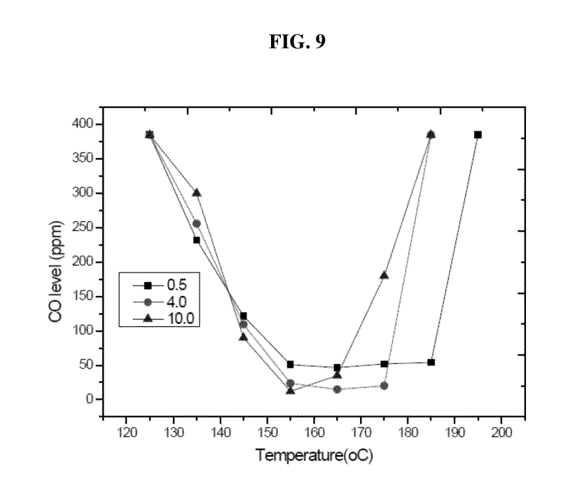

FIG. 9 shows test result regarding Cu contents.

Referring to FIG. 9, CO can be removed to less 10 ppm when Cu is 4, 10 weight % in the catalyst. But, in case of 10 weight %, the range of operation temperature of the catalyst becomes too narrow. Therefore, the preferable contents of Cu is between more than 0.5 weight % and less than 10 weight %.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A catalyst for preferential oxidation for fuel reforming comprising:
a ceria support containing gadolinium; and
a metal catalyst supported on the ceria support.

2. The catalyst for preferential oxidation for fuel reforming of claim 1, wherein the ceria support contains gadolinium in an amount of 0.05-0.1 mol %.

3. The catalyst for preferential oxidation for fuel reforming of claim 1, wherein the metal catalyst is copper.

4. The catalyst for preferential oxidation for fuel reforming of claim 3, wherein the copper is contained in amount of more 0.5 weight % less than 10 weight % to the catalyst.

5. The catalyst for preferential oxidation for fuel reforming of claim 1, wherein the range of operation temperature of the catalyst is equal to or more than 20° C.

6. A fuel reformer containing a catalyst, the catalyst comprises:
a ceria support containing gadolinium; and
a metal catalyst supported on the ceria support.
